(19) United States
(12) Patent Application Publication
(10) Pub. No.: US 2026/0352079 A1
(43) Pub. Date: Nov. 5, 2026

(54) POWER CONDITIONER AND POWER CONTROL METHOD

(71) Applicant: TMEIC CORPORATION, Tokyo (JP)

(72) Inventors: Yoshihiro TAWADA, Tokyo (JP); Mohammad BANI SHAMSEH, Tokyo (JP); Tomoya KATSUKURA, Tokyo (JP)

(73) Assignee: TMEIC CORPORATION, Tokyo (JP)

(21) Appl. No.: 19/486,039

(22) PCT Filed: May 8, 2024
(86) PCT No.: PCT/JP2024/017070

§ 371 Date: Nov. 20, 2025

(51) Int. Cl. H02M 1/00; H02M 7/537

(52) U.S. Cl. CPC H02M 1/0003; H02M 7/537

(57) ABSTRACT

A power conditioner includes an inverter which converts DC power supplied from a DC power supply into AC power and supplies the AC power to a power grid, and a control device which controls the inverter. The control device generates a negative-phase-sequence current command for passing a negative-phase-sequence AC current from the inverter on the basis of a first difference voltage which is a difference between a negative-phase-sequence voltage on an AC side of the inverter and a voltage obtained by removing a high-frequency component of the negative-phase-sequence voltage. The control device performs control so as to stop the inverter if a second difference voltage which is a difference between the negative-phase-sequence voltage and a negative-phase-sequence voltage command obtained by multiplying a characteristic of impedance between the inverter and the power grid by the negative-phase-sequence current command satisfies a threshold condition.

### TECHNICAL FIELD

The present disclosure relates to a technique for controlling a power conditioner.

### BACKGROUND ART

Patent Literature 1 discloses a power conversion device (power conditioner). Specifically, if a negative-phase-sequence voltage on an AC side of an inverter is equal to or more than a predetermined value, the power conditioner judges that the inverter is in islanding operation and performs control so as to stop the inverter.

### CITATION LIST

### Patent Literature

[PTL 1] JP 7151911 B

### SUMMARY OF THE INVENTION

### Problem to be Solved by the Invention

Consider a case where impedance of a three-phase line in a power grid is unbalanced. In this case, in Patent Literature 1, the negative-phase-sequence voltage on the AC side of the inverter may become equal to or more than the predetermined value, and the inverter may be wrongly judged to be in islanding operation.

One object of the present disclosure is to provide a technique capable of appropriately judging whether an inverter is in islanding operation.

### Means for Solving the Problem

A first aspect of the present disclosure relates to a power conditioner. The power conditioner includes an inverter which converts DC power supplied from a DC power supply into AC power and supplies the AC power to a power grid, and a control device which controls the inverter. The control device generates a negative-phase-sequence current command for passing a negative-phase-sequence AC current from the inverter on the basis of a first difference voltage which is a difference between a negative-phase-sequence voltage on an AC side of the inverter and a voltage obtained by removing a high-frequency component of the negative-phase-sequence voltage. The control device performs control so as to stop the inverter if a second difference voltage which is a difference between the negative-phase-sequence voltage and a negative-phase-sequence voltage command obtained by multiplying a characteristic of impedance between the inverter and the power grid by the negative-phase-sequence current command satisfies a threshold condition.

A second aspect of the present disclosure relates to a power conditioner. The power conditioner includes an inverter which converts DC power supplied from a DC power supply into AC power and supplies the AC power to a power grid, and a control device which controls the inverter. The control device judges, if a first difference voltage which is a difference between a negative-phase-sequence voltage on an AC side of the inverter and a voltage obtained by removing a high-frequency component of the negative-phase-sequence voltage is more than 0, whether a positive-phase-sequence voltage on the AC side of the inverter is within a predetermined range. If the positive-phase-sequence voltage is judged to be within the predetermined range, the control device performs control so as to stop the inverter.

A third aspect of the present disclosure relates to a power conditioner. The power conditioner includes an inverter which converts DC power supplied from a DC power supply into AC power and supplies the AC power to a power grid, and a control device which controls the inverter. The control device executes calculating a first difference voltage which is a difference between a negative-phase-sequence voltage on an AC side of the inverter and a voltage obtained by removing a high-frequency component of the negative-phase-sequence voltage, and performing control so as to stop the inverter if a positive-phase-sequence voltage and the negative-phase-sequence voltage on the AC side of the inverter satisfy a predetermined condition.

A fourth aspect of the present disclosure relates to a power control method. The power control method includes using an inverter to convert DC power into AC power and supply the AC power to a power grid, generating a negative-phase-sequence current command for passing a negative-phase-sequence AC current from the inverter on the basis of a first difference voltage which is a difference between a negative-phase-sequence voltage on an AC side of the inverter and a voltage obtained by removing a high-frequency component of the negative-phase-sequence voltage, and performing control so as to stop the inverter if a second difference voltage which is a difference between the negative-phase-sequence voltage and a negative-phase-sequence voltage command obtained by multiplying a characteristic of impedance between the inverter and the power grid by the negative-phase-sequence current command satisfies a threshold condition.

A fifth aspect of the present disclosure relates to a power control method. The power control method includes using an inverter to convert DC power into AC power and supply the AC power to a power grid, judging whether a first difference voltage which is a difference between a negative-phase-sequence voltage on an AC side of the inverter and a voltage obtained by removing a high-frequency component of the negative-phase-sequence voltage is more than 0, judging, if the first difference voltage is judged to be more than 0, whether a positive-phase-sequence voltage on the AC side of the inverter is within a predetermined range, and performing control so as to stop the inverter if the positive-phase-sequence voltage is judged to be within the predetermined range.

A sixth aspect of the present disclosure relates to a power control method. The power control method includes using an inverter to convert DC power into AC power and supply the AC power to a power grid, calculating a first difference voltage which is a difference between a negative-phase-sequence voltage on an AC side of the inverter and a voltage obtained by removing a high-frequency component of the negative-phase-sequence voltage, and performing control so as to stop the inverter if a positive-phase-sequence voltage and the negative-phase-sequence voltage on the AC side of the inverter satisfy a predetermined condition.

### Advantageous Effects of the Invention

According to the first aspect, the negative-phase-sequence current command for passing the negative-phase-sequence AC current from the inverter is generated on the basis of the first difference voltage that is the difference between the negative-phase-sequence voltage on the AC side of the inverter and the voltage obtained by removing the high-frequency component of the negative-phase-sequence voltage. If the second difference voltage that is the difference between the negative-phase-sequence voltage and the negative-phase-sequence voltage command obtained by multiplying the characteristic of the impedance between the inverter and the power grid by the negative-phase-sequence current command satisfies the threshold condition, control is performed so as to stop the inverter. This allows appropriate judgment as to whether the inverter is in islanding operation. Additionally, if the inverter is in islanding operation, the inverter can be stopped early. Thus, safety is secured.

According to the second aspect, if the first difference voltage that is the difference between the negative-phase-sequence voltage on the AC side of the inverter and the voltage obtained by removing the high-frequency component of the negative-phase-sequence voltage is more than 0, it is judged whether the positive-phase-sequence voltage on the AC side of the inverter is within the predetermined range. If the positive-phase-sequence voltage is judged to be within the predetermined range, control is performed so as to stop the inverter. This allows appropriate judgment as to whether the inverter is in islanding operation. Additionally, if the inverter is in islanding operation, the inverter can be stopped early. Thus, safety is secured.

According to the third aspect, the first difference voltage that is the difference between the negative-phase-sequence voltage on the AC side of the inverter and a first voltage obtained by removing the high-frequency component of the negative-phase-sequence voltage is calculated. If the positive-phase-sequence voltage and the negative-phase-sequence voltage satisfy the predetermined condition, control is performed so as to stop the inverter. This allows appropriate judgment as to whether the inverter is in islanding operation. Additionally, if the inverter is in islanding operation, the inverter can be stopped early. Thus, safety is secured.

According to the fourth aspect, the same effects as the first aspect can be obtained.

According to the fifth aspect, the same effects as the second aspect can be obtained.

According to the sixth aspect, the same effects as the third aspect can be obtained.

### BRIEF DESCRIPTION OF THE DRAWINGS

FIG. 1 is a diagram for explaining an outline of a power conversion system according to a first embodiment.

FIG. 2 is a block diagram showing a functional example of a control device according to the first embodiment.

FIG. 3 is a block diagram showing a detection example of islanding operation according to the first embodiment.

FIG. 4 is a diagram for explaining a specific example of a characteristic of the islanding operation according to the first embodiment.

FIG. 5 is a flowchart showing a processing example of the control device according to the first embodiment.

FIG. 6 is a block diagram showing a detection example of islanding operation according to a second embodiment.

FIG. 7 is a flowchart showing a processing example of a control device according to a second embodiment.

FIG. 8 is a block diagram showing a detection example of islanding operation according to a third embodiment.

FIG. 9 is a flowchart showing a processing example of a control device according to the third embodiment.

### DESCRIPTION OF EMBODIMENTS

A power conditioner and a power control method according to an embodiment of the present disclosure will be described with reference to the accompanying drawings.

Elements common among the drawings are denoted by identical reference numerals, and a redundant description thereof will be omitted.

### 1. FIRST EMBODIMENT

### 1-1. Outline of Power Conversion System

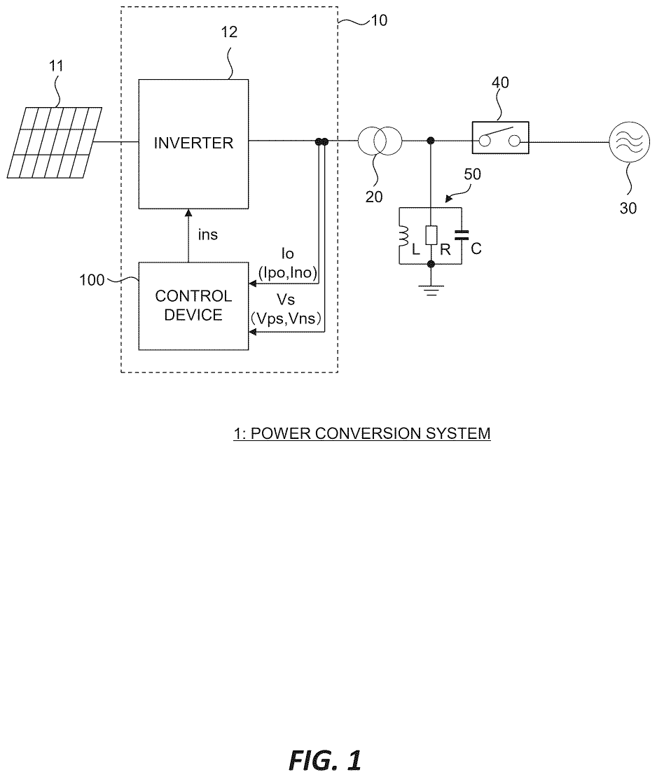

FIG. 1 is a diagram for explaining an outline of a power conversion system 1. The power conversion system 1 includes a DC power supply 11, a power conditioner 10, a transformer 20, a power grid 30, a breaker 40, and a load 50. The power conditioner 10 is configured to include an inverter 12 and a control device 100.

The DC power supply 11 is an electricity storage device (e.g., a solar cell module) which stores electricity generated from renewable energy. Sunlight, wind power, water power, and the like are given as examples of the renewable energy.

The inverter 12 is a device which converts DC power output from the DC power supply 11 into AC power and supplies the AC power to the power grid 30 via the transformer 20. A current-controlled GFL (Grid Following) inverter, a voltage-controlled GFM (Grid Forming) inverter, and the like are given as examples of the inverter 12.

The control device 100 is connected to the inverter 12 and controls the inverter 12. An output voltage Vs and an output current Io which are output from the inverter 12 are input to the control device 100. The output voltage Vs includes a positive-phase-sequence voltage Vps and a negative-phase-sequence voltage Vns. The output current Io includes a positive-phase-sequence current Ipo and a negative-phase-sequence current Ino. Note that the output voltage Vs to be input to the control device 100 refers to, for example, a detection value (hereinafter referred to as a Vs detection value) of the output voltage Vs. The Vs detection value includes a detection value (also referred to as a Vps detection value) of the positive-phase-sequence voltage Vps and a detection value (also referred to as a Vns detection value) of the negative-phase-sequence voltage Vns. The output current Io to be input to the control device 100 refers to a detection value (also referred to as an Io detection value) of the output current Io. The Io detection value includes a detection value (also referred to as an Ipo detection value) of the positive-phase-sequence current Ipo and a detection value (also referred to as an Ino detection value) of the negative-phase-sequence current Ino. These detection values are detected by, for example, a detector (not shown) which is provided between the inverter 12 and the transformer 20.

The control device 100 generates a current command for controlling the output current Io from the inverter 12 on the basis of the Vs detection value and the Io detection value. The control device 100 generates a pulse width modulation signal (PWM signal) on the basis of the current command and issues an instruction ins to the inverter 12 such that the inverter 12 operates in accordance with the PWM signal.

Consider islanding operation of the inverter 12. For example, if the breaker 40 that is provided in a substation or the like on a grid side is opened due to, e.g., a grid accident, AC power output from the inverter 12 coincide with power of the load 50.

This state is called “islanding operation.” If islanding operation of the inverter 12 continues, an electric shock may be given to a human body, a machine may fail, or an overcurrent may be generated at the time of reclosing. Thus, if the inverter 12 is in islanding operation, the inverter 12 needs to be stopped. Note that the load 50 is, for example, a device which is connected to the power conditioner 10 and is consumed in, e.g., a factory where the power conditioner 10 is installed. The load 50 is typically composed of a resistive load R, an inductive load L, and a capacitive load C.

If the inverter 12 is in islanding operation, a slight rise in the negative-phase-sequence voltage Vns causes the inverter 12 to inject the negative-phase-sequence voltage Vns to further raise the negative-phase-sequence voltage Vns.

Consider a case where impedance of a three-phase line is unbalanced on the grid side. In this case, since the three-phase line is not completely balanced, the negative-phase-sequence voltage Vns rises. That is, the negative-phase-sequence voltage Vns rises both in a case where the inverter 12 is in islanding operation and in a case where the impedance of the three-phase line is unbalanced. Thus, a mechanism for distinguishing between the cases is needed.

In the control device 100, a negative-phase-sequence current command for passing a negative-phase-sequence AC current from the inverter 12 is generated on the basis of a first difference voltage which is a difference between the negative-phase-sequence voltage Vns on an AC side of the inverter 12 and a voltage obtained by removing a high-frequency component of the negative-phase-sequence voltage Vns. In the control device 100, if a second difference voltage which is a difference between the negative-phase-sequence voltage Vns and a negative-phase-sequence voltage command obtained by multiplying a characteristic of impedance between the inverter 12 and the power grid 30 by the negative-phase-sequence current command satisfies a threshold condition, control is performed so as to stop the inverter 12. This allows appropriate judgment as to whether the inverter 12 is in islanding operation. Additionally, if the inverter 12 is in islanding operation, the inverter 12 can be stopped early. Thus, safety is secured.

Details of processing by the control device 100 will be described later.

### 1-2. Example of Control Device

### 1-2-1. Configuration Example

The control device 100 has hardware which implements various types of functions. The hardware includes a processing circuit capable of high-speed computing. An FPGA (Field Programmable Gate Array), an ASIC (Application Specific Integrated Circuit), and the like are given as examples of the processing circuit. The hardware may include a storage device and a computing unit (e.g., a CPU or a GPU) which executes a program stored in the storage device, in addition to the processing circuit.

### 1-2-2. Functional Example

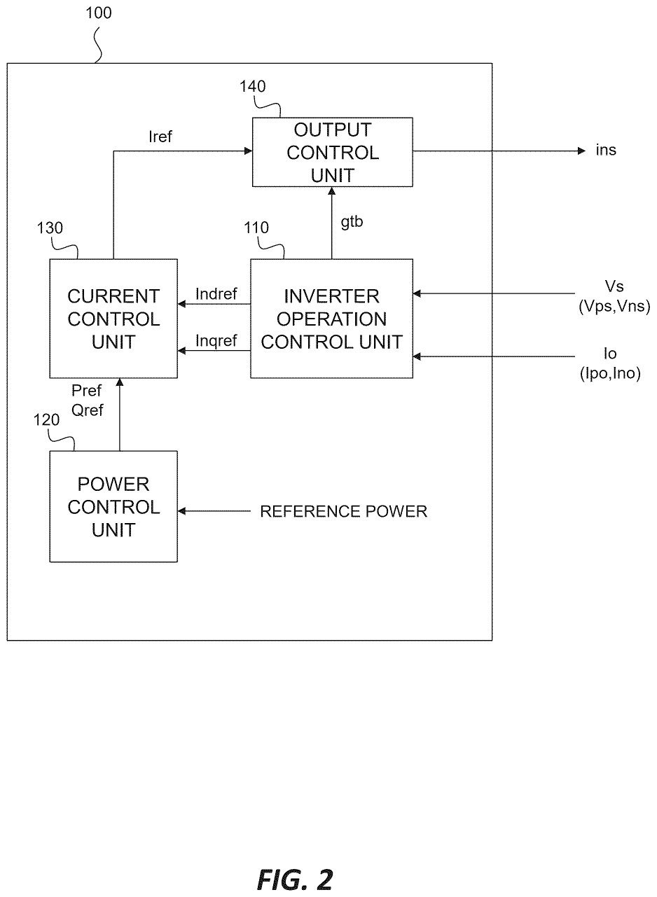

FIG. 2 is a diagram showing a functional example of the control device 100 according to a first embodiment. The control device 100 includes an inverter operation control unit 110, a power control unit 120, a current control unit 130, and an output control unit 140.

The inverter operation control unit 110 generates a negative-phase-sequence current command for passing a negative-phase-sequence AC current from the inverter 12 on the basis of a Vns detection value. The negative-phase-sequence current command includes at least one of a negative-phase-sequence current command Indref which is a d-axis component (hereinafter referred to as the d-axis negative-phase-sequence current command Indref) and a negative-phase-sequence current command Inqref which is a q-axis component (hereinafter referred to as the q-axis negative-phase-sequence current command Inqref).

The inverter operation control unit 110 executes an islanding operation detection process. The inverter operation control unit 110 judges, on the basis of the negative-phase-sequence current command, the Vs detection value, and an Io detection value, whether the inverter 12 is in islanding operation, in the islanding operation detection process. If the inverter 12 is judged to be in islanding operation, the inverter operation control unit 110 outputs a gate block signal gtb for stopping the inverter 12 to the output control unit 140. Details of the islanding operation detection process will be described later.

Note that the Vs detection value to be input to the inverter operation control unit 110 may be obtained via, for example, a PLL (Phase Locked Loop) which is provided in the control device 100. The PLL is a circuit which synchronizes phases of an input voltage signal and an output voltage signal. This allows synchronization of phases of the Vs detection value and the output voltage Vs from the inverter 12 and appropriately interconnects the inverter 12 and the power grid 30.

The power control unit 120 calculates a command value Pref for active power (hereinafter referred to as the active power command value Pref) and a command value Qref for reactive power (hereinafter referred to as the reactive power command value Qref) on the basis of reference power set in advance.

The current control unit 130 generates a current command Iref for controlling the output current Io from the inverter 12 on the basis of the negative-phase-sequence current command value (at least one of the d-axis negative-phase-sequence current command value Indref and the q-axis negative-phase-sequence current command value Inqref), the active power command value Pref, and the reactive power command value Qref.

The output control unit 140 generates a PWM signal in accordance with the current command Iref. If the gate block signal gtb is active, the output control unit 140 issues the instruction ins to stop the inverter 12 to the inverter 12. On the other hand, if the gate block signal gtb is inactive, the output control unit 140 issues the instruction ins to the inverter 12 such that the inverter 12 operates in accordance with the PWM signal.

### 1-2-3. Detection Example of Islanding Operation

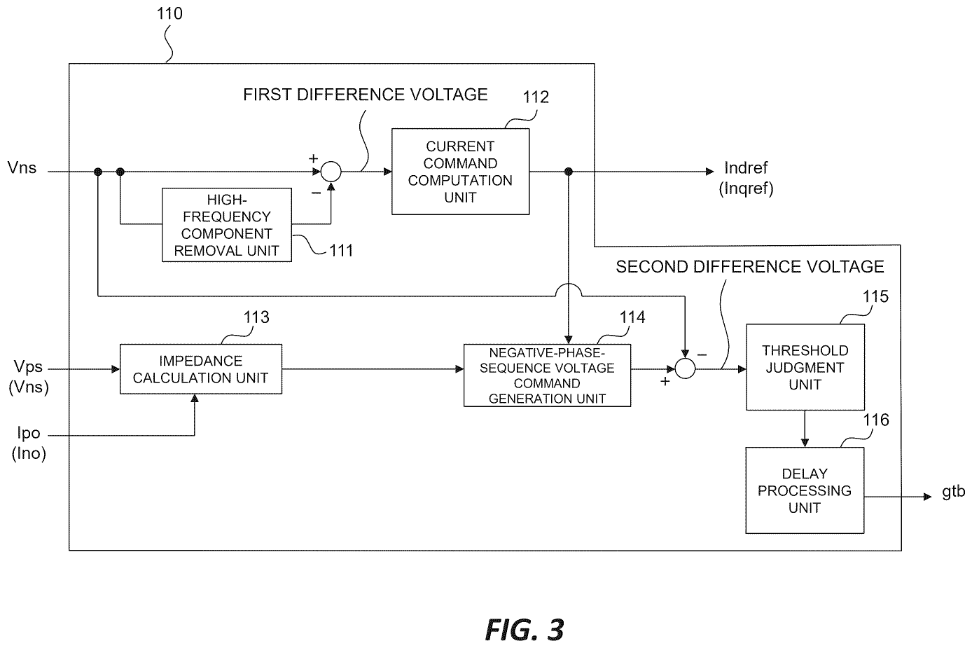

FIG. 3 is a block diagram showing an example of the islanding operation detection process. The islanding operation detection process to be executed by the inverter operation control unit 110 includes a high-frequency component removal unit 111, a current command computation unit 112, an impedance calculation unit 113, a negative-phase-sequence voltage command generation unit 114, a threshold judgment unit 115, and a delay processing unit 116.

The high-frequency component removal unit 111 removes a high-frequency component of the negative-phase-sequence voltage Vns on the AC side of the inverter 12. A voltage obtained by removing the high-frequency component of the negative-phase-sequence voltage Vns is also referred to as a first voltage. As a method for removing the high-frequency component of the negative-phase-sequence voltage Vns, for example, an LPF (Low Pass Filter) is used.

The current command computation unit 112 generates a negative-phase-sequence current command (at least one of the d-axis negative-phase-sequence current command value Indref and the q-axis negative-phase-sequence current command value Inqref) for passing a negative-phase-sequence AC current from the inverter 12 on the basis of a first difference voltage which is a difference between the negative-phase-sequence voltage Vns and the first voltage.

The impedance calculation unit 113 calculates impedance between the inverter 12 and the power grid 30 on the basis of the positive-phase-sequence voltage Vps and the positive-phase-sequence current Ipo. The impedance is a value obtained by diving the positive-phase-sequence voltage Vps by the positive-phase-sequence current Ipo. Note that the impedance may be a value obtained by dividing the negative-phase-sequence voltage Vns by the negative-phase-sequence current Ino. In this case, the negative-phase-sequence voltage Vns and the negative-phase-sequence current Ino are input to the impedance calculation unit 113.

The negative-phase-sequence voltage command generation unit 114 calculates a negative-phase-sequence voltage command by multiplying, by a characteristic of the impedance obtained by the impedance calculation unit 113, the negative-phase-sequence current command obtained by the current command computation unit 112. The negative-phase-sequence voltage command is a command value for passing a negative-phase-sequence AC voltage from the inverter 12.

The threshold judgment unit 115 judges, on the basis of a second difference voltage which is a difference between the negative-phase-sequence voltage Vns and the negative-phase-sequence voltage command obtained by the negative-phase-sequence voltage command generation unit 114, whether a threshold condition is satisfied. The threshold condition is a condition for judging whether the inverter 12 is in islanding operation. If the threshold condition is judged to be satisfied, i.e., the inverter 12 is in islanding operation, the threshold judgment unit 115 generates the gate block signal gtb for stopping the inverter 12. On the other hand, if the threshold condition is judged to be not satisfied, i.e., the inverter 12 is not in islanding operation, the threshold judgment unit 115 deactivates the gate block signal gtb. The deactivation of the gate block signal gtb is, for example, a value of zero. The threshold condition includes a requirement that an absolute value of the second difference voltage be equal to or more than a threshold or a requirement that the second difference voltage is outside a predetermined range. Each of the threshold and the predetermined range used in the threshold condition is, for example, a value which is decided in terms of design on the basis of a specification of the power conversion system 1 (the control device 100).

The delay processing unit 116 delays the timing to output the gate block signal gtb to the inverter 12 for stabilizing the action of the inverter operation control unit 110.

The delay processing unit 116 causes a delay of, for example, several ms.

### 1-2-4. Example of Characteristic of Islanding Operation

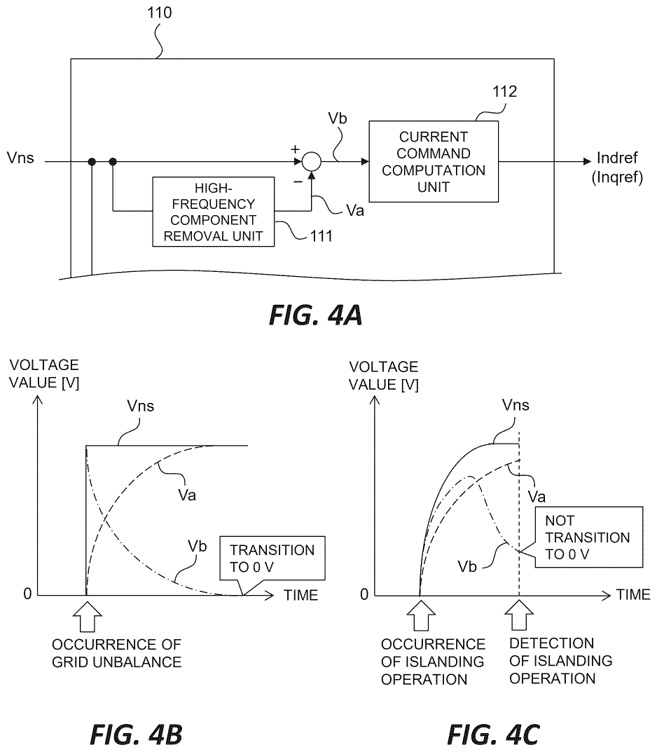

FIG. 4 is a diagram for explaining a specific example of a characteristic of islanding operation. Specifically, (A) in FIG. 4 shows observation points of an output voltage waveform of the high-frequency component removal unit 111. (B) in FIG. 4 shows a resultant example of output voltage waveforms at the observation points when impedance of the three-phase line on the grid side is unbalanced, and (C) in FIG. 4 shows a resultant example of output voltage waveforms at the observation points at the time of islanding operation. The number of observation points is two for a voltage Va and a voltage Vb, as shown in (A) in FIG. 4. The voltage Va is a first voltage which is output from the high-frequency component removal unit 111. The voltage Vb is a first difference voltage obtained by taking a difference between the first voltage and the negative-phase-sequence voltage Vns.

If unbalance occurs on the grid side, as shown in (B) in FIG. 4, the negative-phase-sequence voltage Vns rises. Specifically, the negative-phase-sequence voltage Vns becomes a value more than 0 V. In this case, the voltage Vb (first difference voltage) rises to a value more than 0 V, and then decreases and transitions to 0 V.

If islanding operation occurs, as shown in (C) in FIG. 4, the negative-phase-sequence voltage Vns rises. Specifically, the negative-phase-sequence voltage Vns becomes a value more than 0 V. In this case, although the voltage Vb (first difference voltage) rises to a value more than 0 V and then decreases, the voltage Vb does not transition to 0 V. That is, a voltage value, to which the voltage Vb (first difference voltage) transitions, is different between when the impedance of the three-phase line on the grid side becomes unbalanced and when islanding operation is detected. A detection example of islanding operation using the characteristic will be described in a second embodiment in Section 2.

### 1-3. Processing Example

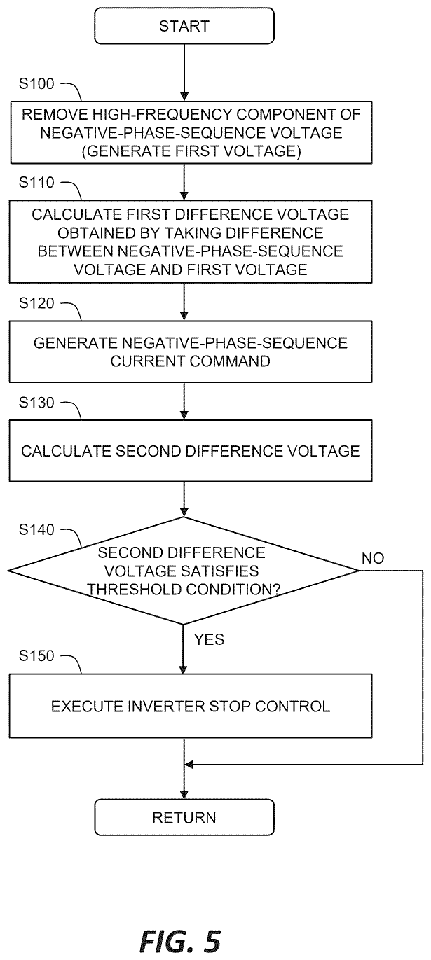

FIG. 5 is a flowchart showing a processing example of the control device 100 according to the first embodiment. Specifically, FIG. 5 schematically shows a detection example of islanding operation.

In step S100, the control device 100 removes a high-frequency component of the negative-phase-sequence voltage Vns to generate the first voltage. After that, the process advances to step S110.

In step S110, the control device 100 calculates a first difference voltage obtained by taking a difference between the negative-phase-sequence voltage Vns and the first voltage. After that, the process advances to step S120.

In step S120, the control device 100 generates a negative-phase-sequence current command for passing a negative-phase-sequence AC current from the inverter 12. After that, the process advances to step S130.

In step S130, the control device 100 calculates a second difference voltage. After that, the process advances to step S140. The second difference voltage is a voltage obtained by taking a difference between the negative-phase-sequence voltage Vns and a negative-phase-sequence voltage command obtained by multiplying a characteristic of impedance between the inverter 12 and the power grid 30 by the negative-phase-sequence current command.

In step S140, the control device 100 judges whether the second difference voltage satisfies a threshold condition. If the second difference voltage satisfies the threshold condition (Yes in step S140), the process advances to step S150. Otherwise (No in step S140), the process ends.

In step S150, the control device 100 determines that the inverter 12 is in islanding operation and executes control for stopping the inverter 12.

### 1-4. Effects

In the power conditioner 10 according to the first embodiment, a negative-phase-sequence current command for passing a negative-phase-sequence AC current from the inverter 12 is generated on the basis of a first difference voltage which is a difference between the negative-phase-sequence voltage on the AC side of the inverter 12 and a first voltage obtained by removing a high-frequency component of the negative-phase-sequence voltage Vns. In the power conditioner 10, if a second difference voltage which is a difference between the negative-phase-sequence voltage Vns and a negative-phase-sequence voltage command obtained by multiplying a characteristic of impedance between the inverter 12 and the power grid 30 by the negative-phase-sequence current command satisfies a threshold condition, control is performed so as to stop the inverter 12. This allows appropriate judgment as to whether the inverter 12 is in islanding operation. Additionally, if the inverter 12 is in islanding operation, the inverter 12 can be stopped early. Thus, safety is secured.

### 2. Second Embodiment

### 2-1. Detection Example of Islanding Operation

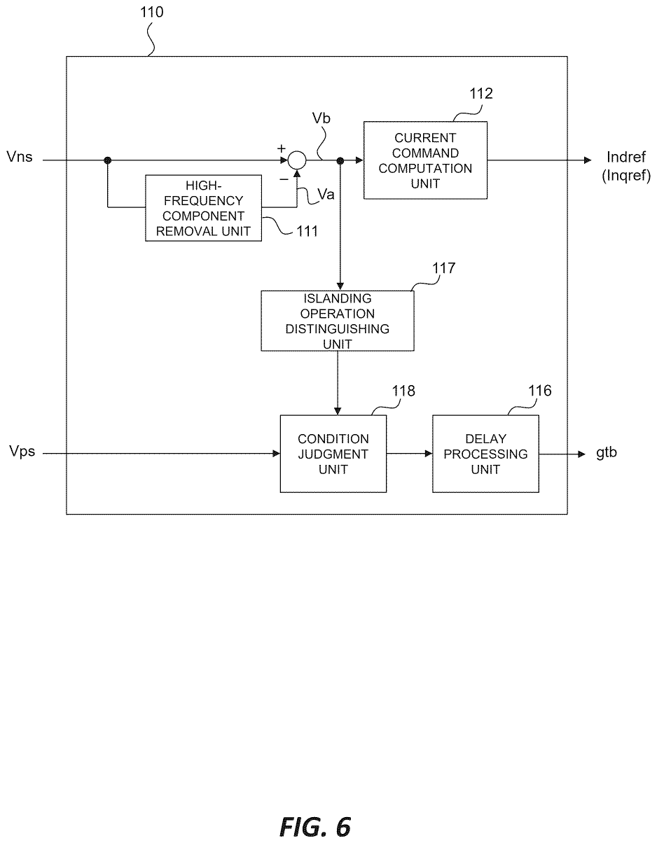

FIG. 6 is a block diagram showing a detection example of islanding operation according to a second embodiment. Specifically, FIG. 6 shows a detection example of islanding operation using a characteristic in which a voltage Vb (first difference voltage) becomes a value more than 0 V when islanding operation is detected.

In the second embodiment, an inverter operation control unit 110 includes a high-frequency component removal unit 111, a current command computation unit 112, an islanding operation distinguishing unit 117, a condition judgment unit 118, and a delay processing unit 116. Since processes by the high-frequency component removal unit 111, the current command computation unit 112, and the delay processing unit 116 are the same as in the first embodiment described above, a description thereof will be omitted. The islanding operation distinguishing unit 117 and the condition judgment unit 118 will be described below.

The islanding operation distinguishing unit 117 judges whether the voltage Vb (first difference voltage) is more than 0. If the voltage Vb (first difference voltage) is judged to be more than 0, the islanding operation distinguishing unit 117 judges that an inverter 12 is in islanding operation. Note that the islanding operation distinguishing unit 117 may judge whether the voltage Vb (first difference voltage) is more than 0 after monitoring a status of the voltage Vb (first difference voltage) for a fixed time period.

For example, if the voltage Vb (first difference voltage) after a lapse of the fixed time period has transitioned to 0 (see (B) of FIG. 4), the islanding operation distinguishing unit 117 judges that the inverter 12 is not in islanding operation. On the other hand, if the voltage Vb (first difference voltage) after the lapse of the fixed time period has not transitioned to 0 (see (C) of FIG. 4), the islanding operation distinguishing unit 117 judges that the inverter 12 is in islanding operation. Thus, it is appropriately determined whether the inverter 12 is in islanding operation.

If a judgment result from the islanding operation distinguishing unit 117 indicates islanding operation, the condition judgment unit 118 judges whether a positive-phase-sequence voltage Vps on an AC side of the inverter 12 is within a predetermined range.

The predetermined range means, for example, an estimated voltage range (hereinafter referred to as an estimated positive-phase-sequence voltage range) of the positive-phase-sequence voltage Vps when impedance of a three-phase line on a grid side is balanced. The predetermined range is decided in terms of design on the basis of a specification of a power conversion system 1 (a control device 100). For example, if the positive-phase-sequence voltage Vps is judged to be within the predetermined range, i.e., the positive-phase-sequence voltage Vps is judged to be within the estimated positive-phase-sequence voltage range, the impedance is assumed to be balanced. In this case, the condition judgment unit 118 determines that the inverter 12 is in islanding operation. On the other hand, if the positive-phase-sequence voltage Vps is judged to be not within the predetermined range, i.e., the positive-phase-sequence voltage Vps is judged to be not within the estimated positive-phase-sequence voltage range, the impedance is assumed to be unbalanced even if a judgment result from the islanding operation distinguishing unit 117 indicates islanding operation. In this case, the condition judgment unit 118 determines that the inverter 12 is not in islanding operation. This leads to more appropriate determination as to whether the inverter 12 is in islanding operation.

If the inverter 12 is determined to be in islanding operation, the condition judgment unit 118 activates a gate block signal gtb for stopping the inverter 12. If the inverter 12 is determined to be not in islanding operation, the condition judgment unit 118 deactivates the gate block signal gtb.

### 2-2. Processing Example

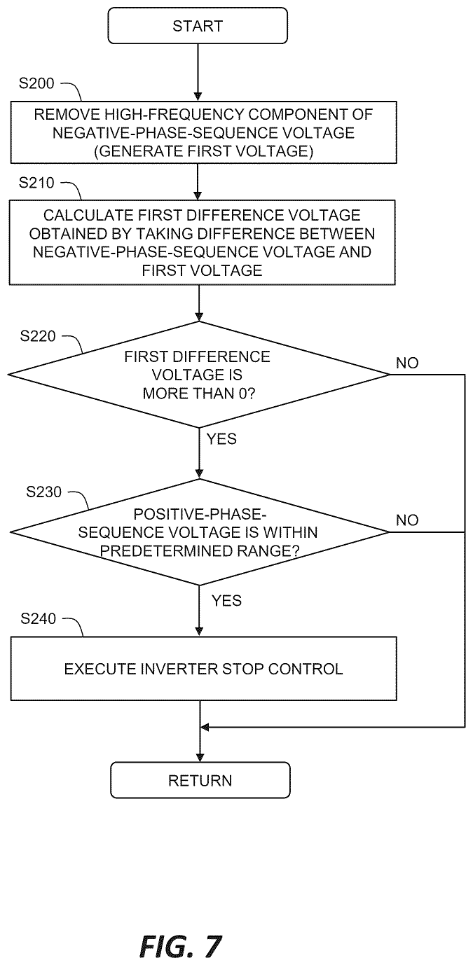

FIG. 7 is a flowchart showing a processing example of the control device 100 according to the second embodiment. Specifically, FIG. 7 schematically shows a detection example of islanding operation.

In step S200, the control device 100 removes a high-frequency component of a negative-phase-sequence voltage Vns to generate a first voltage. After that, the process advances to step S210.

In step S210, the control device 100 calculates a first difference voltage obtained by taking a difference between the negative-phase-sequence voltage Vns and the first voltage. After that, the process advances to step S220.

In step S220, the control device 100 judges whether the first difference voltage is more than 0. If the first difference voltage is judged to be more than 0 (Yes in step S220), the process advances to step S230. Otherwise (No in step S220), the process ends.

In step S230, the control device 100 judges whether the positive-phase-sequence voltage Vps is within a predetermined range. If the positive-phase-sequence voltage Vps is judged to be within the predetermined range (Yes in step S230), the process advances to step S240. Otherwise (No in step S230), the process ends.

In step S240, the control device 100 determines that the inverter 12 is in islanding operation and executes control for stopping the inverter 12.

### 2-3. Effects

In a power conditioner 10 according to the second embodiment, if a first difference voltage which is a difference between the negative-phase-sequence voltage Vns on the AC side of the inverter 12 and a first voltage obtained by removing a high-frequency component of the negative-phase-sequence voltage Vns is more than 0, it is judged whether the positive-phase-sequence voltage Vps is within a predetermined range. If the positive-phase-sequence voltage Vps is judged to be within the predetermined range, it is determined that the inverter 12 is in islanding operation, and control is performed so as to stop the inverter 12. This leads to obtainment of the same effects as in the first embodiment.

### 3. Third Embodiment

### 3-1. Detection Example of Islanding Operation

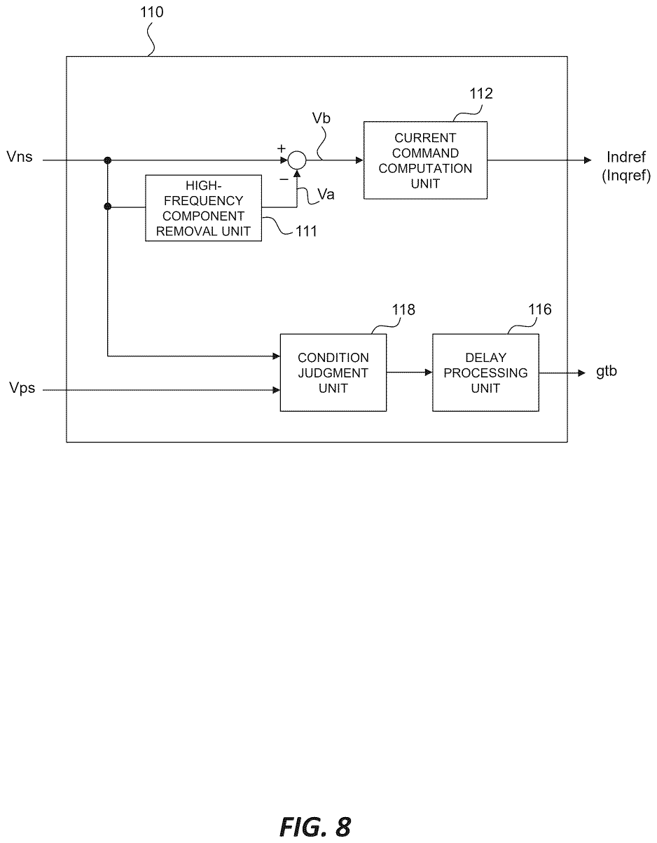

FIG. 8 is a block diagram showing a detection example of islanding operation according to a third embodiment. Specifically, FIG. 8 shows a detection example of islanding operation using a characteristic of a positive-phase-sequence voltage Vps or a negative-phase-sequence voltage Vns.

In the third embodiment, an inverter operation control unit 110 includes a high-frequency component removal unit 111, a current command computation unit 112, a condition judgment unit 118, and a delay processing unit 116. Since processes by the high-frequency component removal unit 111, the current command computation unit 112, and the delay processing unit 116 are the same as in the first embodiment described above, a description thereof will be omitted. The condition judgment unit 118 will be described below.

The condition judgment unit 118 receives the positive-phase-sequence voltage Vps and the negative-phase-sequence voltage Vns. The condition judgment unit 118 judges whether the positive-phase-sequence voltage Vps and the negative-phase-sequence voltage Vns on an AC side of an inverter 12 satisfy a predetermined condition. The predetermined condition includes a requirement that the positive-phase-sequence voltage Vps on the AC side of the inverter 12 be within a predetermined range and a requirement that the positive-phase-sequence voltage Vps on the AC side of the inverter 12 be more than 0. The predetermined range means, for example, an estimated voltage range (estimated positive-phase-sequence voltage range) of the positive-phase-sequence voltage Vps when impedance of a three-phase line on a grid side is balanced. The predetermined range is decided in terms of design on the basis of a specification of a power conversion system 1 (a control device 100).

For example, if the positive-phase-sequence voltage Vps and the negative-phase-sequence voltage Vns satisfy the predetermined condition, i.e., the positive-phase-sequence voltage Vps is within the predetermined range and the negative-phase-sequence voltage Vns is more than 0, it is assumed that the negative-phase-sequence voltage Vns is rising and that the impedance of the three-phase line on the grid side is balanced. In this case, the condition judgment unit 118 determines that the inverter 12 is in islanding operation. On the other hand, if the positive-phase-sequence voltage Vps and the negative-phase-sequence voltage Vns do not satisfy the predetermined condition, it is assumed that the impedance is unbalanced or that the positive-phase-sequence voltage Vps and the negative-phase-sequence voltage Vns are within normal voltage ranges. In this case, the condition judgment unit 118 determines that the inverter 12 is not in islanding operation. This leads to appropriate determination as to whether the inverter 12 is in islanding operation.

If the inverter 12 is determined to be in islanding operation, the condition judgment unit 118 activates a gate block signal gtb for stopping the inverter 12. If the inverter 12 is determined to be not in islanding operation, the condition judgment unit 118 deactivates the gate block signal gtb.

### 3-2. Processing Example

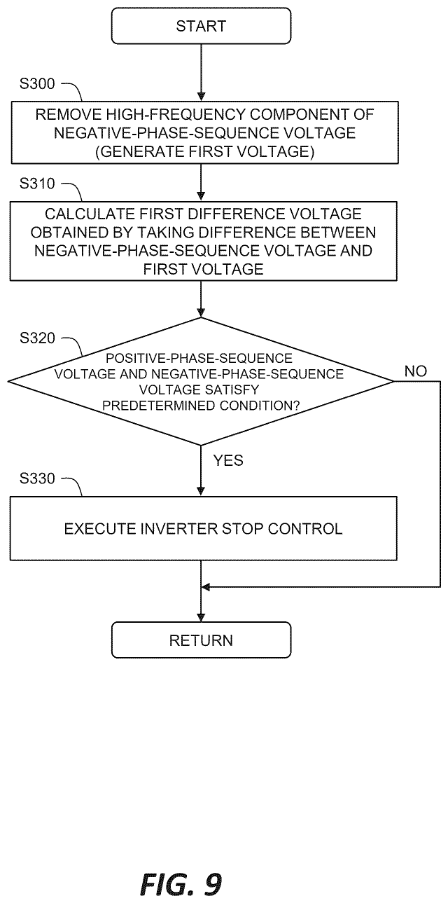

FIG. 9 is a flowchart showing a processing example of the control device 100 according to the third embodiment. Specifically, FIG. 9 schematically shows a detection example of islanding operation.

In step S300, the control device 100 removes a high-frequency component of the negative-phase-sequence voltage Vns to generate a first voltage. After that, the process advances to step S310.

In step S310, the control device 100 calculates a first difference voltage obtained by taking a difference between the negative-phase-sequence voltage Vns and the first voltage. After that, the process advances to step S320.

In step S320, the control device 100 judges whether the positive-phase-sequence voltage Vps and the negative-phase-sequence voltage Vns satisfy the predetermined condition. If the positive-phase-sequence voltage Vps and the negative-phase-sequence voltage Vns are judged to satisfy the predetermined condition (Yes in step S320), the process advances to step S330. Otherwise (No in step S320), the process ends.

In step S330, the control device 100 determines that the inverter 12 is in islanding operation and executes control for stopping the inverter 12.

Note that step S320 may be executed before step S300 and step S310. That is, the control device 100 may be configured to execute steps S300 and S310 and steps S320 and S330 independently.

### 3-3. Effects

In a power conditioner 10 according to the third embodiment, a first difference voltage which is a difference between the negative-phase-sequence voltage Vns on the AC side of the inverter 12 and a first voltage obtained by removing a high-frequency component of the negative-phase-sequence voltage Vns is calculated. In the power conditioner 10, if the positive-phase-sequence voltage Vps and the negative-phase-sequence voltage Vns satisfy the predetermined condition, the inverter 12 is determined to be in islanding operation, and control is performed so as to stop the inverter 12. This leads to obtainment of the same effects as in the first embodiment described above.

### REFERENCE SIGNS LIST

1 Power conversion system
10 Power conditioner
11 DC power supply
12 Inverter
20 Transformer
30 Power grid
40 Breaker
50 Load
100 Control device

1. A power conditioner comprising:
an inverter which converts DC power supplied from a DC power supply into AC power and supplies the AC power to a power grid; and
circuitry which controls the inverter,
wherein the circuitry is configured to
generate a negative-phase-sequence current command for passing a negative-phase-sequence AC current from the inverter on the basis of a first difference voltage which is a difference between a negative-phase-sequence voltage on an AC side of the inverter and a voltage obtained by removing a high-frequency component of the negative-phase-sequence voltage, and
perform control so as to stop the inverter if a second difference voltage which is a difference between the negative-phase-sequence voltage and a negative-phase-sequence voltage command obtained by multiplying a characteristic of impedance between the inverter and the power grid by the negative-phase-sequence current command satisfies a threshold condition.

2. The power conditioner according to claim 1, wherein
the threshold condition includes a requirement that an absolute value of the second difference voltage be equal to or more than a threshold or a requirement that the second difference voltage be outside a predetermined range.

3. The power conditioner according to claim 1, wherein
the impedance is a value which is calculated on the basis of a positive-phase-sequence voltage and a positive-phase-sequence current on the AC side of the inverter and is a value which is obtained by dividing the positive-phase-sequence voltage by the positive-phase-sequence current or is a value which is calculated on the basis of the negative-phase-sequence voltage and a negative-phase-sequence current on the AC side of the inverter and is a value which is obtained by dividing the negative-phase-sequence voltage by the negative-phase-sequence current.

4. The power conditioner according to claim 1, wherein
the negative-phase-sequence current command includes at least one of a negative-phase-sequence current command which is a d-axis component and a negative-phase-sequence current command which is a q-axis component.

5. A power conditioner comprising:
an inverter which converts DC power supplied from a DC power supply into AC power and supplies the AC power to a power grid; and
circuitry which controls the inverter,
wherein the circuitry is configured to
judge, if a first difference voltage which is a difference between a negative-phase-sequence voltage on an AC side of the inverter and a voltage obtained by removing a high-frequency component of the negative-phase-sequence voltage is more than 0, whether a positive-phase-sequence voltage on the AC side of the inverter is within a predetermined range, and
perform control so as to stop the inverter if the positive-phase-sequence voltage is judged to be within the predetermined range.

6. A power conditioner comprising:
an inverter which converts DC power supplied from a DC power supply into AC power and supplies the AC power to a power grid; and
circuitry which controls the inverter,
wherein the circuitry is configured to execute calculating a first difference voltage which is a difference between a negative-phase-sequence voltage on an AC side of the inverter and a voltage obtained by removing a high-frequency component of the negative-phase-sequence voltage, and
performing control so as to stop the inverter if a positive-phase-sequence voltage and the negative-phase-sequence voltage on the AC side of the inverter satisfy a predetermined condition.

7. The power conditioner according to claim 6, wherein
the predetermined condition includes a requirement that the positive-phase-sequence voltage be within a predetermined range and a requirement that the negative-phase-sequence voltage be more than 0.

8.-10. (canceled)
